(19) United States
(12) Patent Application Publication
(10) Pub. No.: US 2011/0318098 A1
(43) Pub. Date: Dec. 29, 2011

(54) Screw-type connector having reinforced locking

(75) Inventors: Daniel GLOAGUEN, Le Mans (FR); Serge LEROYER, Le Mans (FR)

(73) Assignee: SOURIAU, Versailles Cedex (FR)

(21) Appl. No.: 13/168,085

(22) Filed: Jun. 24, 2011

(30) Foreign Application Priority Data
Jun. 24, 2010 (FR) 1055048

(51) Int. Cl. F16B 7/04

(52) U.S. Cl. 403/350

(57) ABSTRACT

A screw-type connector (1) has reinforced locking including a first connection element (2), and a locking ring (10) which is mounted so as to rotate freely about the first connection element which includes at least one ball (3) facing radial teeth (14) on the locking ring, the locking ring being intended to be screwed to a second connection element when the second connection element is connected to the first connection element. The connector includes a resilient element (21) which is mounted between the first connection element and the locking ring and which is capable of being compressed in order to allow a translation of the locking ring in the direction of the second connection element and to allow additional screwing of the locking ring to the second connection element.

The invention relates to a screw-type connector having reinforced locking. More precisely, the invention relates to a device which prevents unintentional unlocking between two complementary elements for electrical, pneumatic, optical or some other type of connection, such as a base and a plug. The device according to the invention also allows the connection to be maintained between the two connection elements, regardless of the conditions of use.

The invention is used in the field of connectivity in general and is particularly advantageous in the field of aeronautical and automotive connectivity, where connectors are often subjected to powerful vibrations.

In some applications, in particular in the field of aeronautical or automotive connectivity, the powerful vibrations cause the connection systems to move, which may bring about a loss of connection between complementary connection elements. Therefore, it is known to provide the connection systems with a device which allows the connection to be locked between the two connection elements and which prevents occurrences of untimely unlocking. Such a device must allow the connection to be maintained, even when the associated connection system is subjected to extreme conditions and in particular to significant vibrations.

In this manner, there is known a screw-type locking device which comprises a locking ring and a row of toothed notches which extend radially from the internal wall of the ring in the direction of the centre of the ring. The locking ring is fixedly joined in translation and can rotate freely about a first connection element or plug body. The plug body is provided with ratchets or a row of toothed notches which are also radial and which are arranged so as to be able to engage on the toothed notches of the locking ring when it is screwed onto the second connection element or base body. The screwing of the locking ring is finished when the plug body and the base body move into abutment against each other. The connection, electrical or otherwise, of the contacts mounted in the plug body and in the base body, respectively, is ensured and theoretically retained.

However, the distance to provide the connection between two complementary connection elements is not always identical from one connection system to another, in particular owing to the production tolerances of the various components.

In this manner, at the end of the locking operation, it is possible for a ratchet or a toothed notch of the plug body about which the locking ring can rotate to be located at the top or along an incline of one of the toothed notches of the locking ring. The connection element is located in an unstable position relative to the locking ring. Consequently, the vibrations to which the connection system is subjected can bring about a slight rotational displacement of the locking ring relative to the plug body until the ratchet is moved into a more stable position between two toothed notches. This rotational displacement brings about an equivalent translational displacement, by the distance between the two connection elements, and, in some cases, the connection elements are no longer in contact, the connection no longer being formed. Furthermore, problems of sealing can occur owing to this spacing which must be prevented in pneumatic connectors and generally in connectors which are intended to be submerged.

An object of the invention is therefore to provide an alternative to known screw-type anti-locking devices which allows the connection between two electrical, pneumatic, optical connection elements, etc., to be maintained even under extreme conditions.

To this end, the invention proposes a system which comprises a locking ring which is mounted so as to rotate freely on a first connection element, such as a plug body, and for which one path in translation along the first connection element can be authorised on command, in order to allow excessive tightening of the ring on a complementary connection element, such as a base body.

That is to say, according to the invention, when the locking ring has finished being screwed to the second connection element, the second connection element moves into mechanical abutment against the first connection element, the compression of a resilient means, mounted between the first connection element and the locking ring, allows the locking ring to be moved longitudinally along the first connection element. The locking ring, which has thus moved forward in the direction of the second connection element can rotate and allow excessive tightening over the corresponding path.

Furthermore, the locking ring is provided with radial engagement means and in particular toothed notches, facing radial engagement means on the first connection element and in particular balls which protrude radially from the wall of the connection element. Therefore, the screwing of the locking ring to the second connection element is accompanied by the engagement of the locking ring on the first connection element. These complementary engagement means prevent the untimely unlocking of the ring relative to the connection elements and allow the connection between the connection elements to no longer be maintained.

The association of a radial system for locking/screwing to an axial system for the over-travel which allows the excessive tightening, allows the two functions to be dissociated and thus allows them to be better controlled independently of each other. Owing to this dissociation, there is further a greater production tolerance for the components of the system according to the invention.

If, at the end of the locking operation, the balls on the first connection element (or the locking ring) are located at the top or on the incline of teeth of the locking ring (or the first connection element), the excessive tightening allows at least one additional tooth to be passed and thus ensures that the balls, at the end of the excessive locking action, are each located in the hollow between two teeth. If, at the end of the locking action, the balls are already in a hollow between two teeth, the excessive tightening allows an additional tooth to be passed. In order to carry out the excessive tightening, the user must apply a torque to the locking ring. He therefore knows that he has reached the end of the travel and he can monitor, in particular by the ratchet noise produced by the engagement of the balls on the toothed notches, that the balls have passed a tooth and that they are between two teeth. Thus, in any case, the balls are in a stable position relative to the toothed notches.

Advantageously, the compression of the resilient element requires additional force, in order to keep it compressed, which allows a higher locking torque to be obtained during the excessive tightening and when beginning to unscrew the locking ring than during the screwing operation.

The invention therefore relates to a screw-type connector having reinforced locking which comprises a first connection element and a locking ring which is mounted so as to rotate freely in rotation about the first connection element, characterised in that the first connection element comprises engagement elements which protrude radially outwards on the first connection element so as to be opposite engagement elements which protrude radially inwards on the locking ring, the locking ring being intended to be screwed to a second connection element when the second connection element is connected to the first connection element in order to lock the connection between the first and the second connection elements, and in that the connector comprises a resilient means which is mounted between the first connection element and the locking ring and which is capable of being compressed in order to allow a forward translation of the locking ring relative to the first connection element, in the direction of the second connection element, and to allow additional screwing of the locking ring to the second connection element.

The term radial protrusion is intended to be understood to mean that the engagement elements extend radially from the wall of the first connection element or the ring relative to the longitudinal axis of the first connection element. The locking ring and the first connection element are mounted so as to be coaxial.

Generally, the terms front and rear are intended to be understood in relation to the connection direction, the front representing the direction which allows the connection between the two complementary connection elements, and the rear representing the direction which allows the disconnection between the two complementary connection elements.

The term forward translation is intended to be understood to mean that the locking ring slides along the first connection element, in the direction of the connection, that is to say, towards the second connection element.

The term additional screwing, or excessive tightening, is intended to be understood to refer to the screwing of the locking ring which is made possible after compression of the resilient element.

The engagement elements on the locking ring and on the first connection element are complementary in so far as the engagement elements of one are capable of engaging with the engagement elements of the other.

In one embodiment of the connector according to the invention, the engagement elements on the first connection element comprise at least one ball which protrudes radially, flush with the outer surface of the wall of the first connection element. And the engagement elements on the locking ring comprise a row of radial teeth which extend radially over a perimeter of the inner surface of the wall of the locking ring. Of course, it is possible to transpose the arrangement of the engagement elements, so that the first connection element comprises the row of radial teeth and the locking ring comprises the balls which protrude radially. It is also possible to provide complementary rows of radial teeth on the locking ring and on the first engagement element.

Of course, when the connector is provided with a plurality of balls, they are arranged on the connection element (or the locking ring) so as to be all simultaneously in the same position with respect to the complementary radial teeth. That is to say, the position of the balls is such that, if a ball is at the top of a tooth, all the other balls on the connector are located simultaneously at the top of the corresponding tooth.

The ball(s) on the first connection element are advantageously each arranged in a radial housing which is provided in a circular collar which extends radially on a perimeter of the external surface of the wall of the first connection element. Each housing opens at the outer surface of the wall, so that the ball opens in the region of the outer surface of the wall. The same applies when the ball(s) is/are supported by the locking ring.

The term radial housing is intended to be understood to mean that the housing extends radially relative to the longitudinal axis of the first connection element.

The term outer surface is intended to be understood to refer to the surface which is directed towards the outer side of the connection element (or of any element in question). Conversely, the term inner surface is intended to be understood to be the surface which is directed towards the inner side of the ring (or of any element in question).

Advantageously, a spring is arranged between a base of the radial housing and the ball in order to retain the ball flush with the surface of the wall of the element in question in order to be able to engage the teeth of the facing rows of radial teeth.

Advantageously, there are four balls, each being arranged at the same distance from the two adjacent balls.

The teeth of the row of radial teeth of the locking ring extend radially on the inner surface of the wall of the locking ring so as to be opposite the balls of the first connection element when the ring is in position on the first connection element. The same applies when the teeth of the row of radial teeth are supported by the first connection element.

In one embodiment, the row of radial teeth comprises predominant teeth whose incline is less in the screwing direction than in the unscrewing direction.

Preferably, the resilient means is sized so that its compression allows a translation which is dependent on the number of teeth on the row of radial teeth and the pitch of the thread between the locking ring and the second connection element. It is known that a complete rotation (360°) of the locking ring corresponds to a translation equal to the pitch of the thread. The additional travel required to pass at least one tooth therefore corresponds to the pitch of the thread divided by the number of teeth.

In one embodiment of the connector according to the invention, the compression of the resilient means allows excessive tightening of the locking ring about the second connection element by a number of degrees equal to 360° divided by the total number of teeth of the row of radial teeth, in order to advantageously allow the ball in question to pass a minimum of one tooth of the row of facing radial teeth and a maximum of two teeth.

Advantageously, the resilient means is sized to allow a translation of the locking ring along the first connection element corresponding at least to the pitch of the thread of the locking ring divided by the total number of teeth of the row of radial teeth.

Preferably, the resilient means is a washer which is mounted coaxially about the first connection element. The washer advantageously surrounds the outer surface of the wall of the first connection element.

According to one embodiment of the invention, the resilient means is retained on the first connection element between a front stop and a rear stop which are formed on the first connection element. The resilient means is arranged at the rear of the connector in order to be located after the complementary engagement elements.

For example, the resilient means is arranged in a housing which is provided between a stop on the first connection element and a stop on the locking ring, the stop on the locking ring being arranged downstream of the stop on the first connection element so that a translation of the locking ring along the first connection element is accompanied by a narrowing of the housing and a compression of the resilient means.

The term downstream is intended to be understood to refer to the rear relative to the connection direction.

The invention will be better understood from a reading of the following description and examination of the appended Figures which are set out by way of example and are in no way limiting in respect of the invention, and in which:

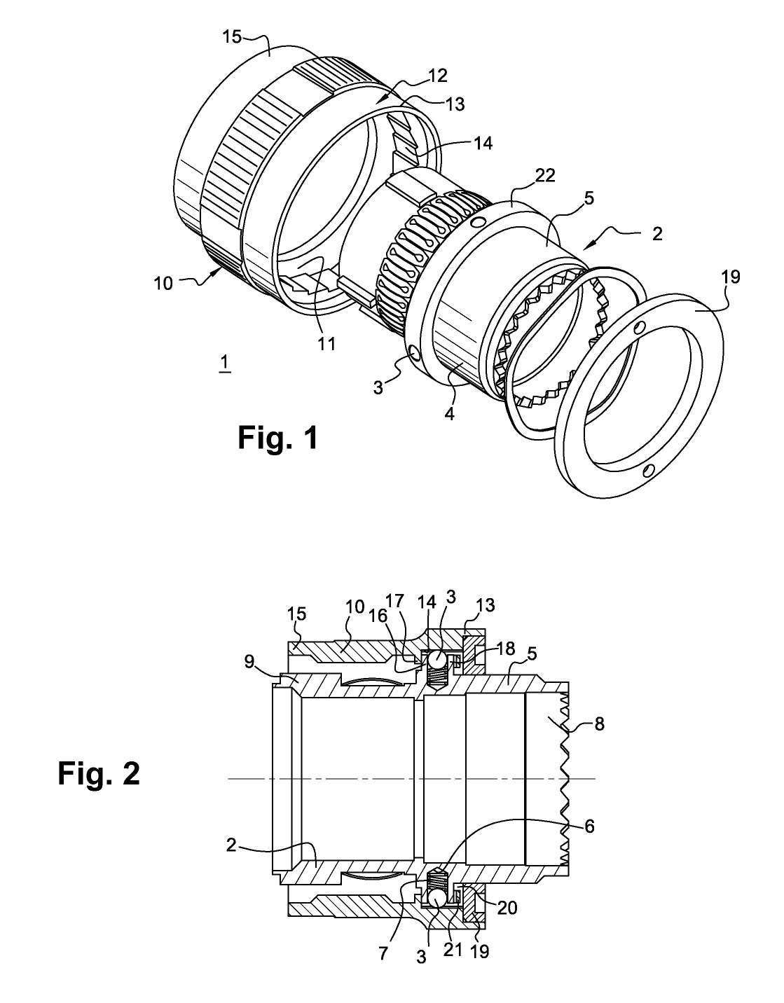

FIG. 1 is an exploded view of a screw-type connector according to one embodiment of the invention;

FIG. 2 is a longitudinal sectional illustration of a screw-type connector according to one embodiment of the invention;

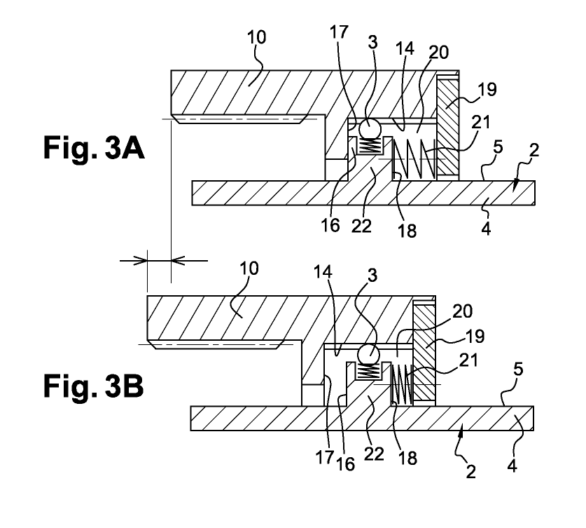

FIGS. 3A and 3B are partial schematic longitudinal sections of a screw-type connector according to the invention in the region of the complementary engagement elements.

FIGS. 1 to 3 illustrate an embodiment of the connector according to the invention in which a first connection element 2, that is to say, a plug, is provided with four balls 3 which protrude radially on the outer surface 4 of the wall 5 of the plug 2 (only two can be seen in FIG. 1). The balls 3 are arranged regularly on the wall 5 of the plug 2 and are thus spaced-apart from each other by 90°.

Each ball 3 is arranged in a radial housing 6 which is provided in a circular radial collar 22 formed on the outer surface 4 of the wall 5 of the plug 2. In order to be kept flush with the outer surface 4 of the wall 5, each ball 3 rests on a helical spring 7 which is arranged at the base of the corresponding housing 6. The spring 7 is thus interposed between the base of the housing 6 and the ball 3. The circular radial collar 22 can be fitted and fixed to the plug 2 or be an integral component of the plug 2.

The plug 2 is intended to receive an insert (not illustrated) which extends longitudinally in a longitudinal cavity 8 of the plug 2, the insert receiving contacts which are also longitudinal.

A front end 9 of the plug 2 (at the left-hand side in FIGS. 1 and 2) is intended to be connected to a base (not illustrated) which is provided with complementary longitudinal contacts.

A locking ring 10 is mounted so as to rotate freely about the plug 2. The inner surface 11 of the wall 12 of the ring 10 is provided, in the region of a rear end 13, with a row 14 of toothed notches, or row 14 of radial teeth, which are arranged on an internal perimeter of the wall 12 of the ring 10. The teeth of the row of toothed notches 14 face the balls 3 on the plug 2 when the locking ring 10 is mounted around the plug 2 (FIG. 2).

The internal surface 11 of the wall 12 of the locking ring 10, in the region of a front end 15, is provided with a screw pitch (not illustrated) in order to be able to be screwed to the outer surface of the wall of a complementary base (not illustrated) when the plug and the base are connected.

The translation, that is to say, the longitudinal movement of the locking ring 10 along the plug 2 is limited by a front stop and a rear stop. More precisely, in the example illustrated here, the front stop is formed by a first radial protrusion 16 on the outer surface of the wall 5 of the plug 2, moving into mechanical abutment with a radial protrusion 17 on the inner surface 11 of the wall 12 of the locking ring 10. Relative to the connection direction between the plug 2 and a complementary base, the radial protrusions 16 and 17 are arranged in front of the engagement means 14 and 3. The rear stop is formed by a second radial protrusion 18 on the outer surface of the wall 5 of the plug 2, moving into mechanical abutment against a circlip 19 which is fitted at the rear portion around the plug 2. The circlip 19 is fixed to the rear end 13 of the locking ring 10 so that it cannot be unintentionally removed.

The radial protrusions 16 and 18 on the outer surface of the wall 5 of the plug 2 are formed by the front wall and the rear wall of the circular radial collar 22 in which the housings 6 which receive the balls 3 are provided, respectively.

According to the invention, a space 20 (FIGS. 3A and 3B) is provided between the second radial protrusion 18 and the circlip 19 of the rear stop in which there is accommodated a resilient means 21, such as a washer (FIGS. 1 and 2), or a circular spring (FIGS. 3A and 3B). The resilient means 21 is generally circular and surrounds the outer surface 5 of the wall 4 of the plug 2. The resilient means 21 is capable of being compressed between the second radial protrusion 18 of the plug 2 and the circlip 19 when the locking ring 10 is drawn forwards, that is to say, towards the base to which it must be screwed. Therefore, before screwing the locking ring 10 to the second connection element and until the screwing is complete, the resilient means 21 is in the rest state, that is to say, in a non-compressed state, so that the second radial protrusion 18 of the plug 2 and the circlip 19 are not in abutment. At the end of the screwing operation, the radial protrusions 16 and 17 are in abutment against each other, but the resilient means 21 is still in the rest state. Only when the maximum screwing of the ring 10 on the second connection element and the desired excessive tightening are obtained is the resilient means 21 compressed.

In FIG. 3A, the locking ring 10 is in mechanical abutment against the front radial protrusion 16 of the plug 2, indicating to the user that the locking of the connection between the plug 2 and the complementary base is complete. The locking ring 10 cannot be screwed further forwards on the base. The connection, electrical or otherwise, between the plug 2 and the base is obtained and potentially must be maintained using the locking ring 10.

As set out above, however, when the locking ring 10 has finished being screwed to the base, the balls 3 are not in a hollow between two teeth of the row 14 of toothed notches of the locking ring 10 but at the top or along the incline of one of them.

Therefore, according to the invention when the user completes the screwing operation, he pulls the locking ring 10 forwards, moving with it the circlip 19 which compresses the resilient element 21, against the rear radial protrusion 18 of the plug 2. The locking ring 2 is no longer in front mechanical abutment and excessive tightening of the locking ring 10 to the base may occur. The user can thus continue the screwing by a few degrees, in order to ensure the position of the balls 3 relative to the radial teeth.

1. Screw-type connector (1) having reinforced locking comprising a first connection element (2), and a locking ring (10) which is mounted so as to rotate freely about the first connection element,
characterised in that the first connection element is provided with a radial circular collar (22) which extends radially on the outer surface (4) of a wall (5) of the first connection element and at least one ball (3) which is arranged in a radial housing (6) of the collar which opens at the outer surface of the wall (5) of the first connection element in order to face a row of radial teeth (14) which are directed towards the inner side on the locking ring, the locking ring being intended to be screwed to a second connection element when the second connection element is connected to the first connection element in order to lock the connection between the first and the second connection elements,
and in that the connector comprises a resilient means (21) which is mounted between the first connection element and the locking ring and which is capable of being compressed in order to allow a forward translation of the locking ring relative to the first connection element, in the direction of the second connection element and to allow additional screwing of the locking ring to the second connection element when the two connection elements move into mechanical abutment.

2. Screw-type connector having reinforced locking according to claim 1, characterised in that a spring (20) is arranged between a base of the radial housing and the ball in order to retain the ball flush with the outer surface of the wall of the first connection element.

3. Screw-type connector having reinforced locking according to claim 1, characterised in that the locking ring is provided with a radial circular collar which extends radially on the inner surface of the wall of the locking ring, the ball being arranged in a radial housing which opens at the inner surface of the wall.

4. Screw-type connector having reinforced locking according to claim 1, characterised in that the compression of the resilient means allows additional rotation of the locking ring about the second connection element corresponding at least to an angle of 360° divided by the total number of teeth of the rows of radial teeth.

5. Screw-type connector having reinforced locking according to claim 1, characterised in that the resilient means is sized so as to allow a translation of the locking ring along the first connection element corresponding at least to the pitch of the thread of the locking ring divided by the total number of teeth.

6. Screw-type connector having reinforced locking according to claim 1, characterised in that the resilient means is a washer mounted coaxially about the first connection element.

7. Screw-type connector having reinforced locking according to claim 1 characterised in that the resilient means is retained on the first connection element between a front stop and a rear stop which are formed on the first connection element.

8. Screw-type connector having reinforced locking according to claim 1, characterised in that the resilient means is arranged in a housing (20) provided between a stop (18) on the first connection element and a stop (19) on the locking ring, the stop on the locking ring being arranged downstream of the stop on the first connection element.

9. Screw-type connector having reinforced locking according to claim 2, characterised in that the compression of the resilient means allows additional rotation of the locking ring about the second connection element corresponding at least to an angle of 360° divided by the total number of teeth of the rows of radial teeth.

10. Screw-type connector having reinforced locking according to claim 2, characterised in that the resilient means is sized so as to allow a translation of the locking ring along the first connection element corresponding at least to the pitch of the thread of the locking ring divided by the total number of teeth.

11. Screw-type connector having reinforced locking according to claim 2, characterised in that the resilient means is a washer mounted coaxially about the first connection element.

12. Screw-type connector having reinforced locking according to claim 2, characterised in that the resilient means is retained on the first connection element between a front stop and a rear stop which are formed on the first connection element.

13. Screw-type connector having reinforced locking according to claim 2, characterised in that the resilient means is arranged in a housing (20) provided between a stop (18) on the first connection element and a stop (19) on the locking ring, the stop on the locking ring being arranged downstream of the stop on the first connection element.
